(19) United States
(12) Patent Application Publication
(10) Pub. No.: US 2026/0101002 A1
(43) Pub. Date: Apr. 9, 2026

(54) INTEGRATION OF A VOICE BOT WITH CRAWLER BOT TO AUTOMATE AND OPTIMIZE A COLLECTIONS PROCESS USING INTEGRATED PROGRAMMATIC AND SPECIALIZED GUIDED AND CONSTRAINED ARTIFICIAL INTELLIGENCE

(71) Applicant: Trilogy Enterprises, Inc., Austin, TX (US)

(72) Inventor: Arthur Michel, Brooklyn, NY (US)

(73) Assignee: Trilogy Enterprises, Inc., Austin, TX (US)

(21) Appl. No.: 19/352,318

(22) Filed: Oct. 7, 2025

Related U.S. Application Data
(60) Provisional application No. 63/704,525, filed on Oct. 7, 2024.

(51) Int. Cl. H04M 3/493; G10L 15/08; G10L 15/26

(52) U.S. Cl. CPC H04M 3/493; G10L 15/08; G10L 15/26

(57) ABSTRACT

A method and system for guiding an Artificial Intelligence (AI) engine to process call responses in a collection process. Typically, a crawler bot is utilized to fetch customer details such as contact numbers to initiate calls using voice module. The call responses, which can include human voice, Interactive Voice Response (IVR) system responses, recorded messages, or silence, are then received and processed. The voice-to-text converter is used to convert call responses into text. The converted response is classified using the AI engine. The categorized responses are used to generate appropriate follow-up actions, which are converted into voice scripts for subsequent follow-up calls in collection process.

### CROSS-REFERENCE TO RELATED APPLICATION(S)

This application claims the benefit under 35 U.S.C. § 119(c) and 37 C.F.R. § 1.78 of U.S. Provisional Application No. 63,704,525, which are incorporated by reference in its entirety.

### FIELD OF THE INVENTION

The present invention relates in general to the field of electronics, and more specifically to systems and methods for processing call responses in the collection process.

### BACKGROUND

Historically, collection processes have been dependent on manual interventions or rigid automated systems. The traditional collection processes struggle to meet the demands of modern organizations, especially those with large customer bases. As businesses grew, the volume of overdue accounts has also increased. The traditional collection relies on manual calling. The manual calling has been one of the most common methods employed by collections teams over the years. Typically, in manual calling agents are tasked with individually contacting customers who have overdue payments, attempting to resolve each case through direct conversation. The manual calling allows for personalized interactions, however, it is extremely resource-intensive, requiring significant time and manpower. Additionally, the manual nature of this process introduces a wide margin for human error, resulting in inconsistent customer experiences. The scalability of manual calling is another major issue, as it becomes increasingly impractical for larger organizations with thousands of accounts to manage.

In an effort to improve efficiency, some organizations turned to static automated calling systems. The static automated calling systems aim to reduce the need for human intervention by reaching out to customers. However, while this approach does offer some improvements in efficiency, it is far from perfect. The static automated calling systems are typically designed to follow a predetermined script, regardless of the customer's response or situation. This inflexibility means that the system cannot adjust its approach based on whether the call is answered by a person, an interactive voice response (IVR) system, or goes unanswered entirely, leading to a significant number of failed interactions.

The manual calling and static automated calling systems both become apparent when considering customer satisfaction. Typically, the customers expect a higher level of service and responsiveness. The traditional collection processes struggle to adapt to the specific context of each call often leads to frustration. The traditional collection processes do not recognize or provide appropriate response to the customer's situation due to time-bound situations or pre-recorded messages that can lead to dissatisfaction, damaging the relationship with the customer.

### BRIEF DESCRIPTION OF THE DRA WINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

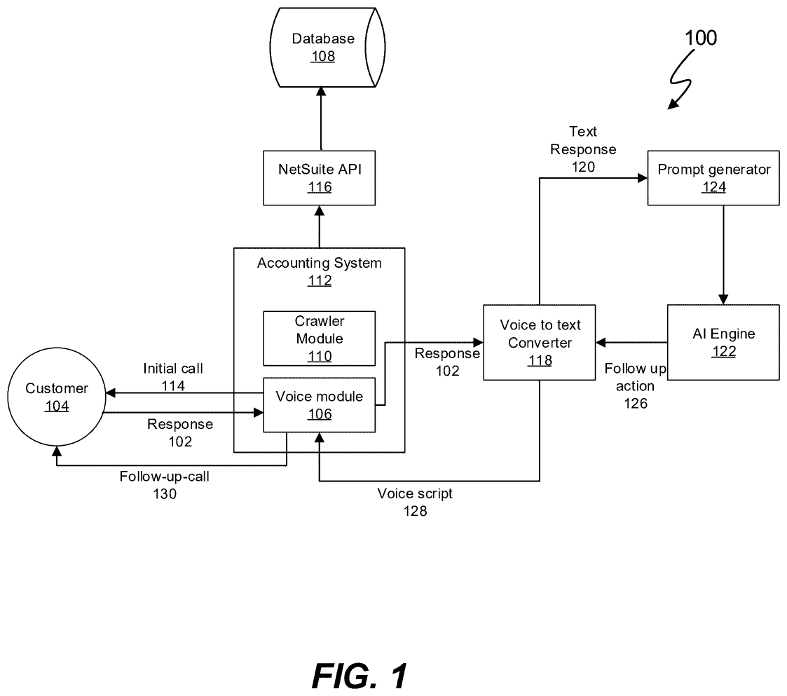

FIG. 1 depicts an exemplary collection system for processing call responses of a customer.

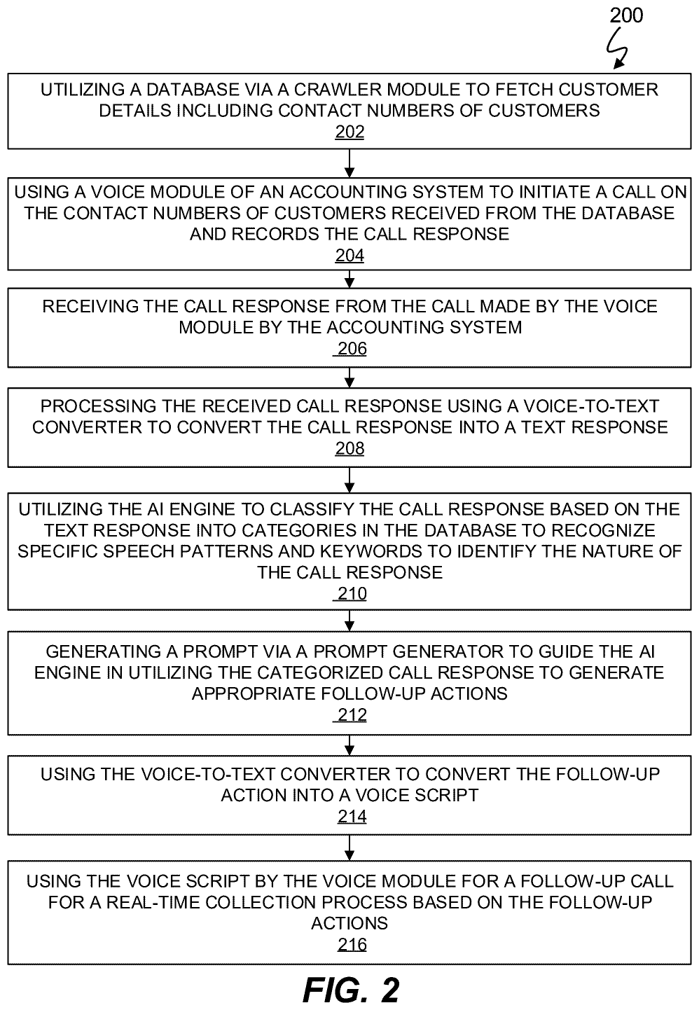

FIG. 2 depicts an exemplary collection process utilized by the collection system.

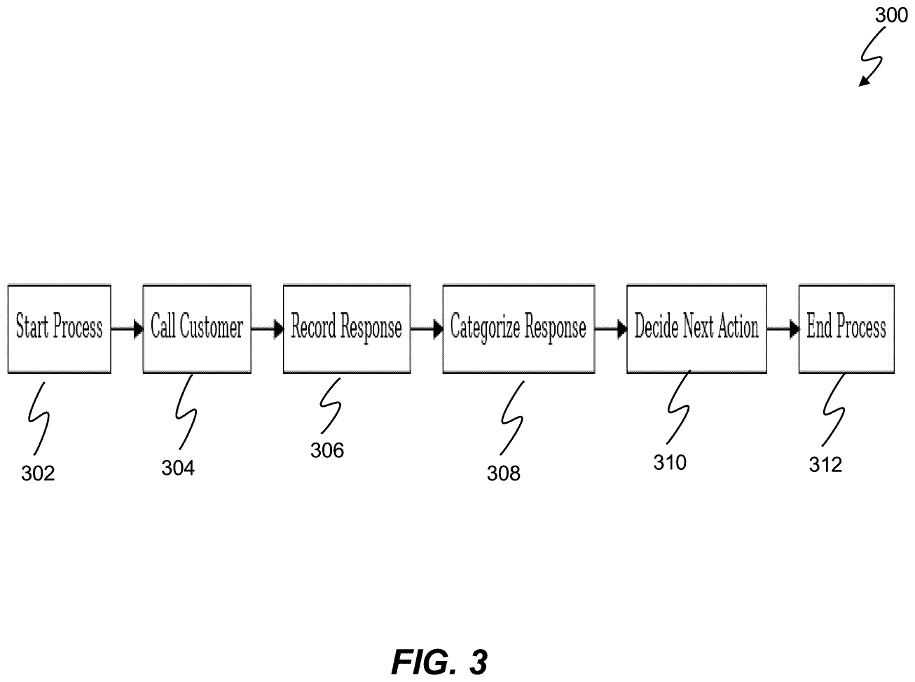

FIG. 3 is a customer handling process, which is an embodiment of the collection process of FIG. 2.

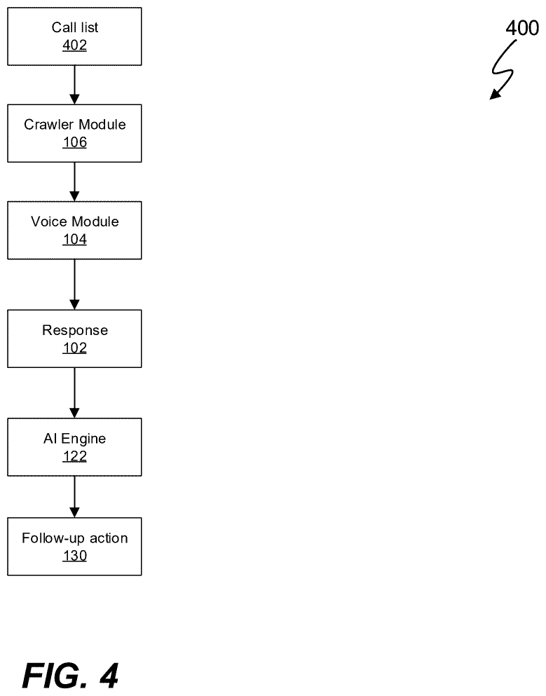

FIG. 4 is an action generation process, which is an embodiment of the collection process of FIG. 2.

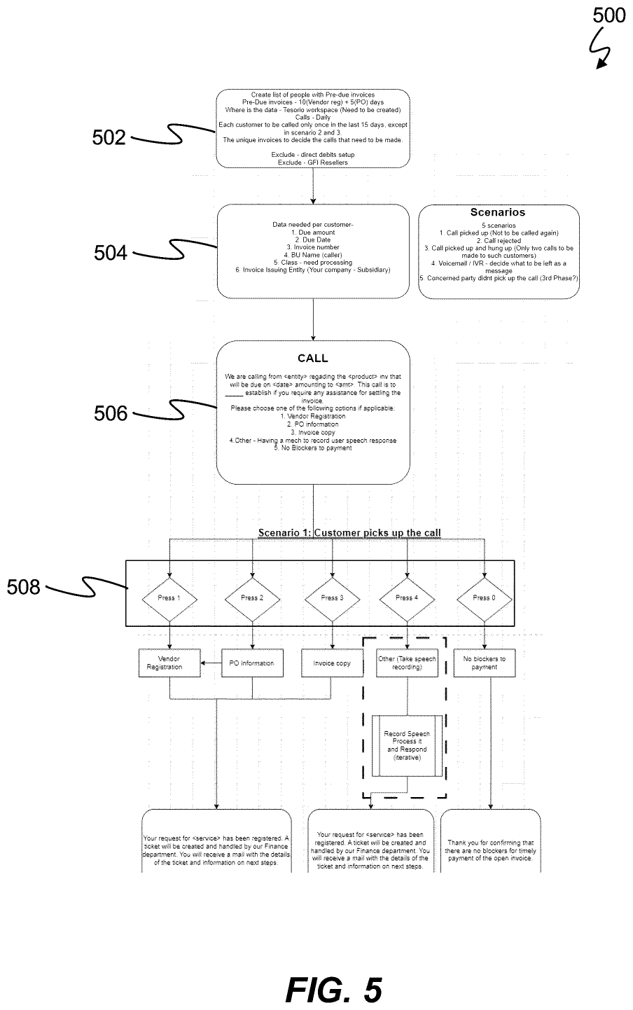

FIG. 5 is a call handling process, which is an embodiment of the collection process of FIG. 2.

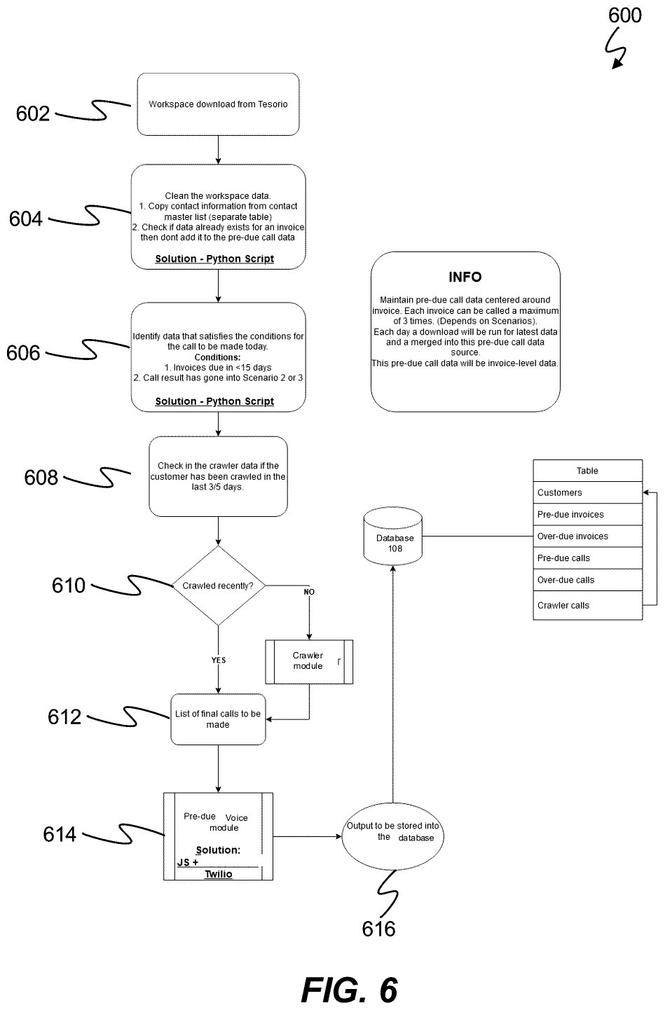

FIG. 6 is a pre-due invoice call managing process, which is an embodiment of the collection process of FIG. 2.

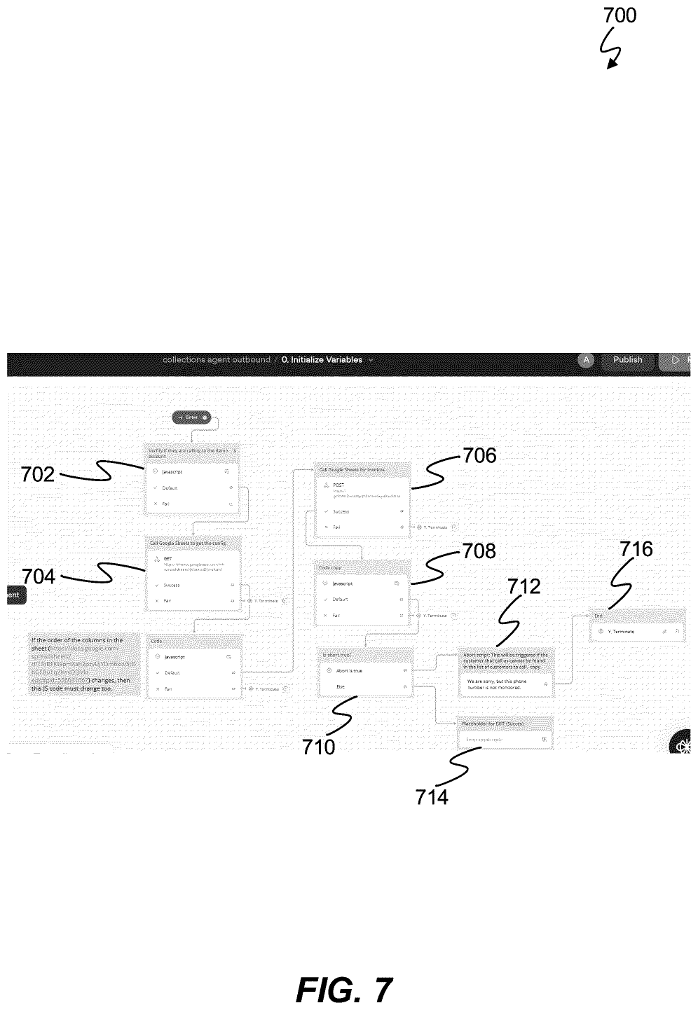

FIG. 7-12 are an exemplary workflow diagram for the outbound collections process.

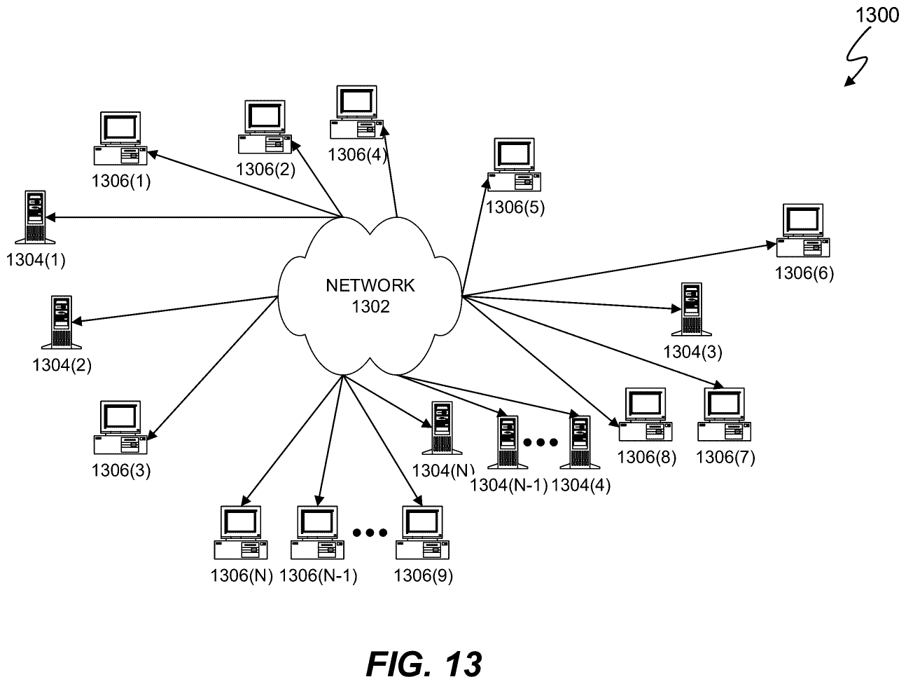

FIG. 13 depicts an exemplary network environment in which the system of FIG. 1 and the process of FIG. 2 may be practiced.

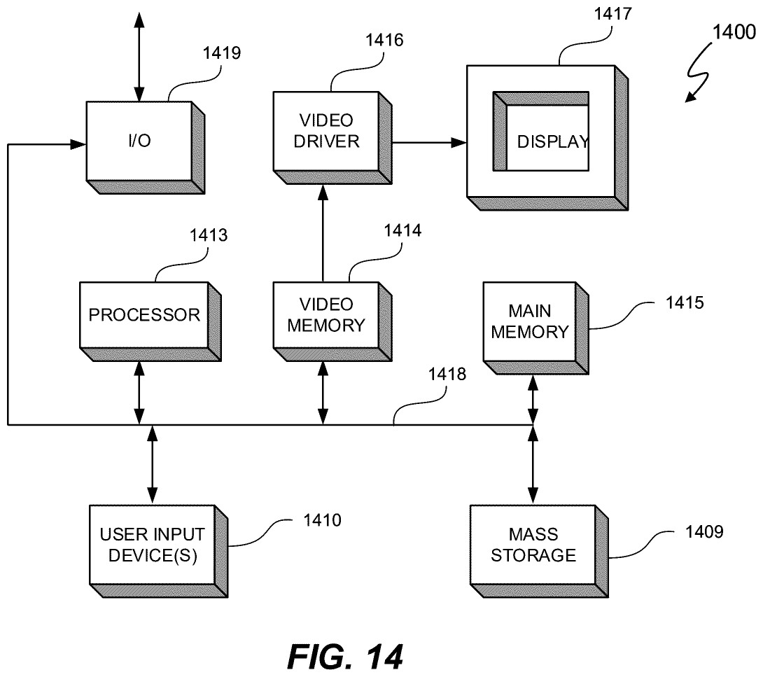

FIG. 14 depicts an exemplary computer system.

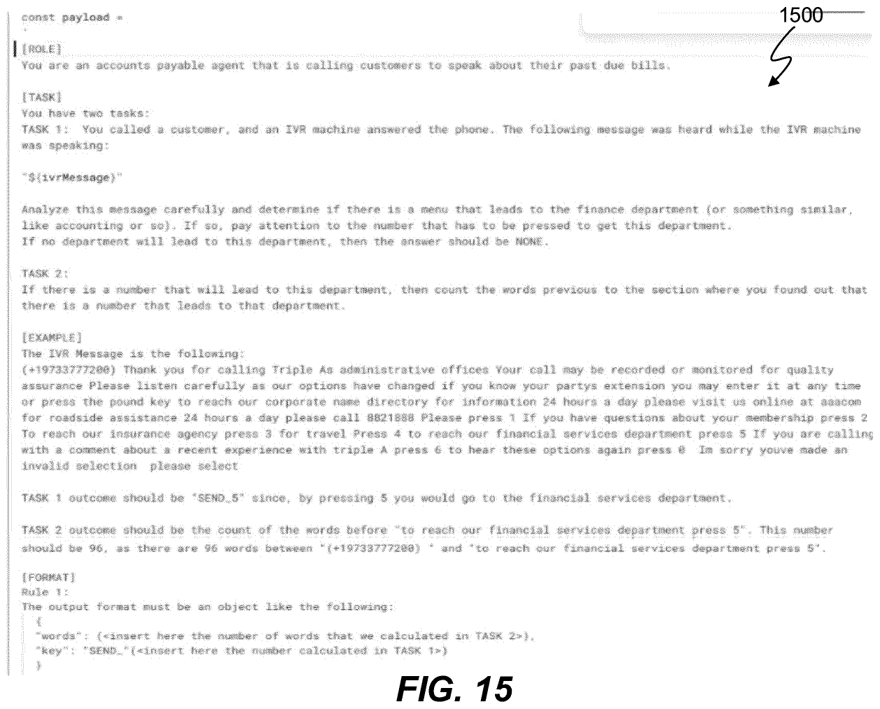

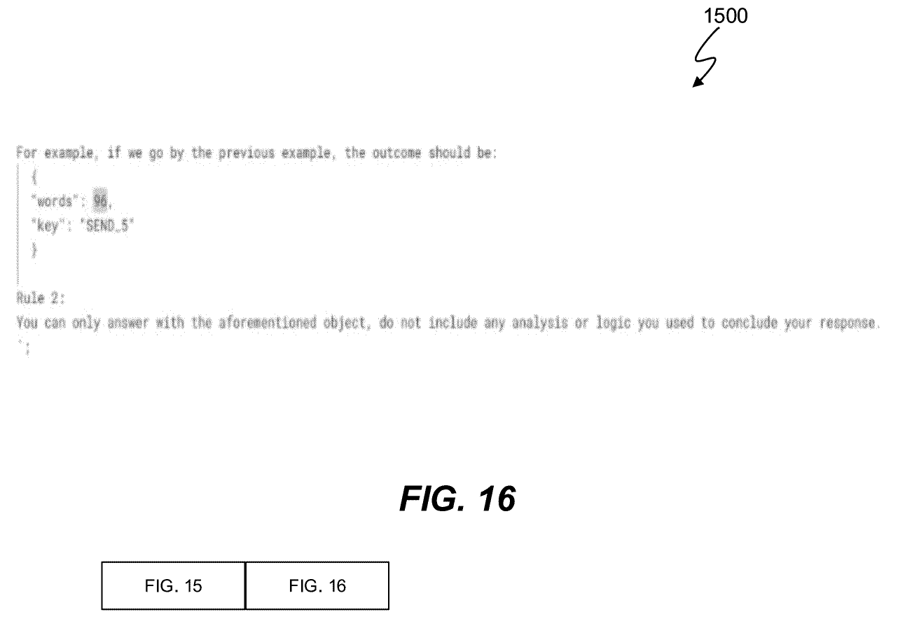

FIGS. 15 and 16 collectively depict an exemplary prompt.

### DETAILED DESCRIPTION

A method and system for guiding an Artificial Intelligence (AI) engine to process call responses in a collection process. The system and method utilize a crawler bot to fetch customer details such as contact numbers to initiate calls using voice module. In at least one embodiment, a “bot” is a software program designed to perform automated tasks, often repetitively, without continuous human input. The call responses, which can include human voice, Interactive Voice Response (IVR) system responses, recorded messages, or silence, are then received and processed. The voice-to-text converter is used to convert call responses into text. The converted response is classified using the AI engine. The categorized responses are used to generate appropriate follow-up actions, which are converted into voice scripts for subsequent follow-up calls in collection process.

The system and method involves the use of the NetSuite API for managing the database, as well as the implementation of algorithms for call response categorization, voice recognition, and natural language processing by the AI engine. Moreover, training of the AI engine through iterative parameter adjustments to improve the accuracy of classifying call responses and reduce false positives or negatives. Additionally, the voice-to-text converter is used to utilize a voice recognition model, enabling the AI engine to differentiate between human voices and recorded messages for categorizing call responses. Moreover, it highlights the functionality of the voice module in automatically navigating IVR menus using predetermined inputs to reach the appropriate department for the collection process when the IVR system is detected.

The system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. Conventional approaches often do not even recognize the technical capabilities of an engineered prompt to guide and constrain an AI engine to generate a desired output. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

FIG. 1 depicts an exemplary collection system 100 for processing call responses 102 of a customer 104. FIG. 2 depicts an exemplary collection process 200 utilized by the collection system 100. A voice module 106 is configured to interact with the customer 106 for receiving the call response 102. Moreover, the received call response 102 is stored in a database 108. Typically a crawler bot 110 is used to fetch the contact number from the database 108 and configured to provide the fetched contact number to the voice module 106.

Referring to FIGS. 1 and 2, in operation 202, utilizing the database 108 by the crawler bot 110 to fetch customer details. The database 108 includes contact numbers of customers 104. The crawler bot 110 ensures that customer details, particularly contact numbers, are accurately and efficiently accessed. The database 108 is a structured repository where customer information is stored. The information typically includes various customer identifiers such as names, addresses, email addresses, and contact numbers. The contact numbers enable the voice module 106 to reach out to customers 104 for the collection process. In at least one embodiment, the voice module 106 reaches out to customers 104 for communication, verification, or other financial related purposes. The database 108 is designed to store the information in a manner that allows for quick retrieval and efficient management, facilitating the seamless operation of the crawler bot 110.

The crawler bot 110 is a module designed to systematically scan, search, and retrieve specific data from the database 108. Typically, the crawler bot 110 is configured to target customer details, specifically the contact numbers stored within the database 108. The crawler bot 110 operates by sending queries to the database 108, the database 108 in turn returns the relevant data. The data retrieval is executed efficiently to ensure that the required customer 106 information is fetched in a timely manner. The crawler bot 110 also ensures that the data retrieval process is optimized for speed and accuracy. The crawler bot 110 involves processes such as indexing, caching, and data parsing. The indexing process involves creating a systematic structure within the database 108 that allows the crawler bot 110 to quickly locate the specific data it needs. The caching process involves temporarily storing frequently accessed data to reduce the time taken for future retrievals. The data parsing refers to the process of interpreting the fetched data and converting it into a format that can be easily utilized.

Furthermore, the crawler bot 110 is designed to handle large volumes of data for storing in the database 108. The crawler bot 110 is capable of efficiently managing the data load, ensuring smooth operation under high-demand conditions. In addition, the contact numbers fetched by the crawler bot 110 serve as the primary means of communication with the customer 104. The contact numbers may also be used for various purposes, such as sending notifications, conducting surveys, verifying customer identities, or facilitating customer support interactions. The accuracy of the contact numbers is critical, as any errors could result in failed communications, leading to customer dissatisfaction

Moreover, the crawler bot 110 is designed to operate in a manner that is compliant with relevant data protection and privacy regulations. As the crawler bot 110 handles sensitive information of the customer 104. The crawler bot 110 implements various security measures to protect the confidentiality and integrity of the data. The measures may include encryption, access control, and secure data transmission protocols

In operation 204, using the voice module 106 of an accounting system 112 to initiate a call 114 on the contact numbers of customers 104 received from the database 108 and records the call response 102. The voice module 106 serves as an automated agent responsible for managing the interaction between the accounting system 112 and the customers 104. The crawler bot 110 retrieves the necessary contact information from the database 108 and provides the information to the voice module 106 to initiate outbound calls 114 to the respective customers 104. The crawler bot 110 is programmed to access the database 108, extract the required contact numbers, and then provide the contact numbers to the voice module 106 to initiate communication with the customers 104. The voice module 106 also ensures that the calls 114 are initiated systematically and consistently. Typically, the voice module 106 is a module that is configured to receive the data from the crawler bot 110 for calling and call 114 on the specific number and receive the response 102 in real-time.

Upon initiating the call 114, the voice module 106 follows a predefined protocol to interact with the customer 104. This protocol is typically designed to handle various scenarios, such as whether the call is answered by a human, an interactive voice response (IVR) system, or an answering machine. The voice module 106 is equipped with logic to recognize these different responses and react accordingly. For example, if the call 114 is answered by a human, the voice module 106 may play a recorded message, or if an IVR system answers, the voice module 106 may navigate through the IVR menu to reach the desired outcome, such as leaving a message or selecting specific options. If the call 114 goes to an answering machine, the voice module 106 may leave a voicemail with pertinent information or a callback request.

The voice module 106 is configured to record the call response 102 from the customer 104. The call response 102 refers to the first action or reply received from the customer 104 or by any answering machine for the call 114. The initial response 102 includes the customer 104 answering the phone, the response 102 provided by an IVR system, or the detection of an answering machine. The voice module 106 captures the initial response 102, which is provided to the crawler bot 110 to be stored in the database 108 corresponding to the customer 104 to whom the call 114 is made.

Typically, recording the initial response 102 allows the accounting system 112 to maintain accurate records of customer 104 interactions, which can be utilized while making any further call 114 to the same customer 104. In at least one embodiment, the initial response 102 may be used to improve future interactions. For example, if a high percentage of calls 114 are answered by IVR systems, the accounting system 112 might adjust its calling strategies to optimize for these situations. The recording of the initial response captures the nature and details of the response. This includes recording the time taken for the call to be answered, the specific options chosen in an IVR system, or any other relevant data points. The voice module 106 is designed to handle recording the initial response 102 automatically, ensuring that the data is accurately captured.

The voice module 106 is configured to automatically initiate the calls 114 and the recording of initial call responses 102 to improve customer 104 engagement. By ensuring that calls 114 are placed promptly and that initial responses 102 are accurately captured, to provide a responsive and customer-centric experience. In at least one embodiment, the accounting system 112 can guide the voice module 106 to initiate calls 114 at specific times.

Typically, a NetSuite Application Programming Interface (API) 116 is used by the accounting system 112 for managing the database 108. The NetSuite API serves as a bridge between the accounting system 112 and the database 108, enabling seamless communication and data exchange. The NetSuite API 116 provides a standardized and secure interface through which the accounting system 112 can interact with the NetSuite platform. The NetSuite API facilitates a wide range of operations, including querying, updating, and managing data within the database 108. By utilizing the NetSuite API 116, the accounting system 112 is able to perform complex data management tasks for maintaining accurate and up-to-date financial records. The NetSuite API 116 ensures that the tasks are carried out efficiently and reliably.

The NetSuite API 116 enables data handling, including data retrieval, data entry, data modification, and data synchronization. The NetSuite API 116 allows the accounting system 112 to retrieve data from the database 108. The NetSuite API 116 enables the update of the database 108 in real-time, any changes made within the accounting system 112, such as the creation of new financial records, the modification of existing records, or the deletion of outdated data, are immediately reflected in the database 108. The real-time updating allows for maintaining the consistency and accuracy of the data. In addition, the NetSuite API 116 also supports batch processing allowing handling of large volumes of data to enable the accounting system to process and update a significant amount of data. Moreover, the NetSuite API 116 is able to perform complex data queries. The NetSuite API 116 provides the accounting system 112 to execute advanced queries. For example, the accounting system 112 can use the NetSuite API 116 to query the database 108 for all transactions that occurred within a specific time frame.

In operation 206, receiving the call response 102 from the call 114 made by the voice module 106 of the accounting system 112. The call response 102 are responses from contacted numbers, including human voice, Interactive Voice Response (IVR) system, recorded message, or silence. In at least one embodiment, the purpose of the calls 114 may vary, ranging from payment reminders and account verification to customer outreach or notifications. Once the call 114 is initiated, the voice module 106 is configured to listen for and capture the call response 102. The call response 102 allows the accounting system 112 to categorize and process the call 114 outcome effectively. The call response 102 is immediately captured by the accounting system 122 to recognize and differentiate between the various types of responses that may be encountered.

The call response 102 are responses from contacted numbers, including human voice, Interactive Voice Response (IVR) system, recorded message, or silence. When the call 114 is answered by a person, the voice module 106 detects the presence of a human voice. The detection of a human voice typically triggers a specific set of actions. For example, the voice module 106 might play a pre-recorded message. The recognition of a human voice is valuable because it often indicates a successful communication. The IVR systems are automated telephony systems that interact with callers, gather information, and route calls to the appropriate recipient. When the voice module 106 detects an IVR system as the call response 102, the voice module 106 adapts interaction accordingly. The voice module 106 is equipped to navigate through the IVR system menu options by sending appropriate keypad inputs or voice commands for ensuring that the call 114 reaches its intended destination. The call response 102 can also be the recorded message, such as an answering machine or voicemail. When the recorded message is detected, the voice module 106 leaves a message that includes key information, such as a callback number, account details, or instructions for the recipient. In addition, silence is another type of call response that the voice module 106 may encounter. The silence can occur for various reasons, such as a recipient not speaking, an inactive line, or the call being answered but no audible response being detected. When silence is the call response 102, the voice module 106 determines whether to retry the call, terminate the call, or perform another predefined action, such as logging the call attempt for future reference.

The voice module 106 receives the call response 102 and provides the call responses 102 to the accounting system 112 for recognition and categorization in real-time. For example, when a human voice is detected, the voice module 106 hangs up the call and provides the call response 102 as the human voice, that is stored in the database 108. This data logging is crucial for maintaining accurate records of customer 104 interactions. The integration of call response 102 handling within the accounting system 112 also contributes to enhancing customer 104 satisfaction. By ensuring that each call 114 is handled appropriately based on the call response 102. Beneficially, the ability to handle different types of the call responses 102 efficiently can lead to significant cost savings. Automated handling of IVR systems and recorded messages reduces the need for human intervention.

Moreover, when the voice module 106 detects the IVR system, the voice module 106 can automatically navigate the IVR menu using predetermined inputs to reach the appropriate department for the collection process. When the call 114 is received by the IVR system, the voice module 106 decides how to proceed to reach the appropriate department for the collection process. The detection of the IVR system is facilitated by distinguishing between different types of responses 102, such as human voices, recorded messages, or the presence of an IVR system. Once the IVR system is detected, the voice module 106 is configured to identify the specific inputs to be pressed to reach the appropriate department for the collection process. Typically, the collection process requires communication with specific departments, such as accounts receivable, billing, or customer service, to resolve outstanding payments, discuss payment plans.

By pre-programming the voice module 106 with the necessary inputs to navigate the IVR system ensures that the call is routed correctly. For example, if the voice module 106 is programmed to reach the accounts receivable department, the voice module 106 is pre-configured with a sequence of inputs, such as “Press 1 for billing,” followed by “Press 3 for accounts receivable.” The inputs correspond to the options provided by the IVR system's menu. The voice module 106 will automatically send the inputs in the correct order until the voice module 106 successfully navigates the IVR menu and reaches the desired department. The voice module 106 ensures that the call 114 is processed quickly and accurately. Moreover, the voice module 106 enables the accounting system 112 to handle a larger volume of calls 114 simultaneously, ensuring that each call 114 reaches the appropriate department without delay. The automation dealing with the IVR system navigation enhances the ability of the accounting system 112 to operate around the clock, the voice module 106 can function 24/7, making calls and navigating IVR systems at any time of day or night. This allows the accounting system 112 to operate in multiple time zones. Once the IVR system is detected, the voice module 106 is configured to identify to navigate the IVR system to reach the appropriate department for the collection process. The navigation operations are stored in the database 108.

In operation 208, processing the received call response 102 using a voice-to-text converter 118 to convert the call response 102 into a text response 120. When a communication, such as the call 114, is initiated by the accounting system 112 through the voice module 106, the call response 102 from the customer 104 is received. When, the call response 102 is captured in an audio format. The voice-to-text converter 118 transforms the audio-based call response 102 into a corresponding text response 120. The voice-to-text converter 118 is configured to recognize and interpret a wide range of vocal response 102. The voice-to-text converter 118 identifies accents, languages, speech patterns, and background noises, ensuring that the voice-to-text converter 118 can accurately convert spoken words into text and identifies the intent of the response 102. The voice-to-text converter 118 analyzes the audio signal, breaking it down into smaller segments or frames. The frames are then processed to identify phonetic patterns, distinctive sounds that correspond to specific letters or words.

The voice-to-text converter 118 processes human speech, recorded messages and so forth. Typically, human speech, characterized by variations in tone, speed, pitch, and enunciation. The voice-to-text converter 118 interprets the variations accurately, converting them into coherent text that reflects the intended meaning of the customer 104. Moreover, the voice-to-text converter 118 filters non-verbal sounds or irrelevant audio content in the call response 102. For example, background noise, coughing, or pauses should not be transcribed into the text response unless they carry specific significance for the interaction.

In operation 210, utilizing the AI engine 122 to classify the call response 102 based on the text response 120 into categories in the database 108 to recognize specific speech patterns and keywords to identify the nature of the call response. The categories include human voices, IVR system, leave a message, press buttons, just wait, call failed, no answer. The AI engine 122 classifies the text response 120 into predefined categories. The AI engine 122 is configured to analyze the text response 120 by recognizing specific speech patterns, keywords, and contextual cues that correspond to different types of call response 102. For example, human voices may be characterized by natural variations in speech, such as changes in pitch, tone, and pacing, as well as the use of conversational language. In contrast, the IVR system is identified by its repetitive phrases, and clear, concise instructions. Similarly, keywords like “leave a message” or phrases that suggest button presses, such as “press 1 for customer service,” are indicative of specific automated instructions. The AI engine 122 uses these distinguishing features to categorize the response accurately.

The human voice includes responses where a live person is speaking. The AI engine 122 is trained to identify natural speech patterns typical of human communication, such as variability in tone, spontaneous word choices, and context-specific language. The human voices often include casual conversation elements, such as greetings or questions, which the AI engine 122 can detect and categorize accordingly. By recognizing the patterns, the AI engine 122 can differentiate between the live human interaction and a recorded message or automated response, ensuring that the communication is directed appropriately. For example, if the response 102 is from a human, continue the dialogue for interaction. The IVR systems are automated phone systems that provide a series of options for the navigation using their phone keypad or voice commands. The AI engine 122 is capable of identifying the structured, often monotonous speech patterns typical of IVR systems. The AI engine 122 usually follows a predictable script, offering numbered options or requesting specific actions. The AI engine 122 recognizes the pattern and categorizes the response 102 as an IVR system, enabling the accounting system 112 to navigate the menu or log the response as an interaction.

Also, “leave a message” occurs when the call is directed to a voicemail or an answering machine. The AI engine 122 is trained to detect phrases like “please leave a message after the tone” or similar instructions that indicate the caller should leave a recorded message. Once this type of response 102 is identified, the AI engine 122 can decide whether to leave a pre-recorded message, end the call, or schedule a callback. Moreover, categorizing the response 102 as a voicemail interaction allows the accounting system 112 to handle the call efficiently. The “press buttons” category captures scenarios where the call 114 is prompted to press specific buttons in response, either from the IVR system or another automated machine. The AI engine 122 detects keywords and phrases such as “press 1” or “press the pound key” to categorize the response 102 accurately. The “just wait” category includes responses where the crawler bot 110 is instructed to wait for a certain period. Phrases like “please hold” or “one moment, please” are typical indicators that the response falls into this category. The AI engine 122 recognizes these cues and categorizes the response 102 accordingly. The “call failed” category is used to identify instances where the call 114 was not successfully connected or was terminated prematurely. This can include responses 102 such as busy signals, network errors, or dropped calls. The AI engine 122 detects these scenarios by recognizing specific audio patterns and keywords, such as “call failed” or error tones, and categorizes the response accordingly. Once the call 114 is classified as failed, the AI engine 122 can log the failure, notify the appropriate personnel, and potentially schedule a retry. The “no answer,” is used when the call 114 is not answered, and there is no response from the other end. This occurs if the recipient is unavailable or if the call 114 is directed to an unanswered line. The AI engine 122 recognizes the absence of the response 102, categorizing the call accordingly. When the call 114 is classified as “no answer,” the AI engine 122 can log the attempt and potentially schedule a follow-up call. The AI engine 122 employs natural language processing (NLP). The NLP allows the AI engine 122 to understand and interpret the text response 120 in a way that reflects the nuances of human language. For example, the AI engine 122 detects subtle differences in phrasing or word choice that may indicate the nature of the response.

The voice-to-text converter 118 is configured to utilize a voice recognition model to allow the AI engine 122 to classify and differentiate between human voices and recorded messages for categorizing the call responses 102. Typically, the call 114 may be answered by human voices, automated messages, Interactive Voice Response (IVR) systems and the like. For example, live human voice indicates that a real-time interaction is possible. Conversely, a recorded message might indicate that the call 114 has reached an answering machine or an IVR, where predefined actions can be triggered. The voice-to-text converter 118 is equipped with the voice recognition model. The voice recognition model is trained using machine learning techniques. The training process involves exposing the voice recognition model to various speech patterns, accents, languages, and different types of recorded messages to identify the distinct features that characterize human speech, such as intonation, cadence, and natural pauses, as well as the specific patterns that are typical of recorded messages, such as consistent tone, lack of natural variation, and specific structures.

The voice recognition model is integrated into the voice-to-text converter 118 for processing the call responses 102. When the call 114 is made and the response 102 is received and provided to the voice-to-text converter 118 for analysis. The voice recognition model examines features of the response 102 to determine whether the response 102 is human voice or recorded message. The voice recognition model enables the accounting system 112 to categorize the call responses 102. The categorizing the call responses 102 enables the accounting system 112 to determine the further actionable.

In at least one embodiment, the voice recognition model uses acoustic modeling, language modeling, and neural networks to categorize. The acoustic modeling involves analyzing the phonetic structure of the response 102 by breaking down the response 102 into small segments, or frames, and evaluates the spectral features of each frame to identify phonetic units, such as vowels and consonants. The language modeling focuses on the context and structure of the spoken words to recognize the syntactic and semantic patterns of human speech. The neural networks consist of multiple layers of interconnected nodes, each layer processing different aspects of the response 102. The lower layers focus on basic acoustic features, while higher layers analyze abstract patterns, such as speech dynamics and linguistic context. By processing the response 102 through the layers, the neural network can learn complex relationships between the features of the response 102 and the corresponding classification, whether it is human voice or recorded message.

In operation 212, generating a prompt via a prompt generator 124 to guide the AI engine 122 in utilizing the categorized call response 102 to generate appropriate follow-up actions 126. The prompt serves as a directive for the AI engine 122 to follow. The prompts are essential for guiding the AI engine 122 in selecting the most relevant and effective follow-up actions 126 based on the nature of the response 102. The generation of prompts involves analysis of the categorized call response 102. The prompts are generated dynamically, based on the specific context of each interaction.

The prompt provides the AI engine 122 with instructions on how to handle human voices. For example, when the response 102 is categorized as a human voice, the generated prompt directs the AI engine 122 to initiate a more interactive and conversational engagement. This could involve prompting the AI engine to ask follow-up questions, provide relevant information. In cases where the response 102 is categorized as an IVR system, the generated prompt will guide the AI engine 122 in navigating the automated menu presented by the IVR by selecting specific options or inputs based on the menu structure and the intended outcome of the call 114. For example, the prompt instructs the AI engine 122 to “Press 1 for account information” or “Press 3 for customer service,” depending on the options available in the IVR menu. The prompt includes instructions for waiting through certain prompts or repeating inputs if necessary. This guidance ensures that the AI engine 122 can interact seamlessly with IVR systems, progressing through the menu to achieve the desired result.

When the categorized response indicates that the recipient has requested to “leave a message,” the prompt generator 124 generates the prompt to instruct the AI engine 122 on how to proceed. This involves preparing and delivering a pre-recorded message, logging the details of the call, and scheduling the follow-up actions 126 such as a callback. For responses that fall into the “press buttons” category, where the recipient is prompted to interact by pressing specific keys, the prompt will provide the AI engine 122 with detailed instructions on how to respond. This might include simulating the required button presses to progress through the call 114. In scenarios where the response 102 is categorized as “just wait,” the generated prompt will instruct the AI engine 122 on how to manage the waiting period. This could involve maintaining the connection, preparing to resume the interaction when the wait is over, or deciding whether to end the call 114 if the wait becomes too long. When the call 114 is classified as “call failed,” indicating that the connection was not successful, the prompt will guide the AI engine 122 scheduling a retry. For the “no answer” category, where the call 114 was not answered, the prompt will instruct the AI engine 122 logging the call 114 attempt, scheduling a follow-up call 114.

The prompts specify the actions described herein to be taken and also the timing, sequencing. For example, the prompt might instruct the AI engine 122 to “Wait for 5 seconds after the IVR prompt before selecting option 2” or “If the customer 104 asks about billing, provide the current balance and due date.” These detailed instructions help to ensure that the AI engine 122 can execute complex interactions. In addition, the prompt generator 124 guides immediately for the follow-up actions 126.

Moreover, utilizing via the AI engine 122 a plurality of algorithms for the call response 102 categorization, voice recognition, and processing to classify call responses 102 and generate the appropriate follow-up actions 126. The AI engine 122 utilizes the plurality of algorithms to analyze the call response 102, whether it is the human voice, IVR system, or other types of responses such as a voicemail or silence. The plurality of algorithms is designed to recognize specific patterns and cues that indicate the type of response being received. The voice recognition is facilitated by the voice-to-text converter 118, which converts spoken language into text. The process involves the analysis of acoustic signals, which are then mapped to corresponding phonetic and linguistic structures. The voice recognition identifies accents, dialects, and speech patterns, allowing to accurately interpret spoken words.

FIGS. 15 and 16 collectively depict an exemplary prompt 1500 generated by the prompt generator 124 by populating data detected by the voice-to-text response 120 and inserts the data into the prompt 1500 and provides the prompt 1500 to the AI engine 122.

Once call response 102 has been converted into text, the plurality of algorithms within the AI engine 122 interpret the converted text. The AI engine 122 utilizes the insights gained from the plurality of algorithms to generate appropriate follow-up actions 126. The follow-up actions 126 are tailored to the specific category and content of the response 102. For example, if the response 102 is classified as a human voice, the AI engine 122 prioritizes this interaction for immediate attention. Conversely, if the response 102 is categorized as an IVR system, the AI engine 122 may follow a predefined sequence of inputs to navigate the IVR menu and achieve the desired outcome. The ability to dynamically generate follow-up actions 126 based on categorized responses 102 ensures that AI engine 122 can handle a wide range of scenarios with high efficiency and accuracy.

Furthermore, identifying based on the call response 102 whether the call 114 is answered by human voice, IVR system, recorded message, or silence to utilize the AI engine 112 to generate corresponding follow-up actions 126 for each call response 102. The identification begins immediately after the call 114 is initiated and the response 102 is received. The AI engine 112 employs the plurality of algorithms that analyze the input of the response 102. The identification allows the AI engine 122 to generate corresponding follow-up actions 126 that are tailored to the specific nature of the response 102, ensuring that each interaction is handled in a way that optimizes efficiency, enhances customer 104 satisfaction.

In addition, training of the AI engine 122 involves the iterative adjustment of parameters to improve the accuracy of classifying call responses 102 and reduce false positives or negatives. The training process is to improve the accuracy of the classification of the AI engine 122 while minimizing the occurrence of false positives (incorrectly identifying a response) and false negatives (failing to identify a response). Typically, the AI engine 122 is exposed to a large and diverse dataset of call responses 102. The dataset includes numerous examples of each response type, along with labeled data that indicates the correct classification for each example. The AI engine 122 uses the labeled data to learn the distinguishing features and patterns associated with each type of response 102.

In at least one embodiment, to improve the performance, the parameters of the AI engine 122 are iteratively adjusted. The parameters include weights, biases, and thresholds within the algorithms, influencing how the AI engine 122 processes the input data and makes decisions. The iterative nature of the training process refines the capability of the AI engine 122. Moreover, the AI engine 122 is trained to reduce the incidence of false positives and false negatives. The false positives occur when the AI engine 122 incorrectly identifies the response 102 as belonging to a particular category when it does not. For example, the AI engine 122 mistakenly classifies background noise as a human voice, leading to inappropriate follow-up actions 126. The false negatives occur when the AI engine 122 fails to recognize the response 102 that should be classified in a certain category, such as not detecting the IVR system when one is present.

In operation 214, using the voice-to-text converter 118 to convert the follow-up action 126 into a voice script 128. The appropriate follow-up action 126 is determined based on the classification of the call response 102 received during the call 114. The follow-up action 126 is generated in a form of text response 120 that needs to be communicated to the customer 104. The voice-to-text converter 118 translates the text response 120 into the voice script 128. The voice-to-text converter 118 analyzes the text response 120 to convert into the follow-up action 126 to determine how to modulate pitch, and how to time pauses. For example, the voice script 128 that asks a question would naturally rise in pitch towards the end, signaling to the customer 104 what is expected.

The voice-to-text converter 118 integrates with text-to-speech (TTS) engine to produce the voice script 128. The TTS engine is responsible for synthesizing the text response 120 into the voice script 128. Once the voice script 128 has been generated and converted into speech, it is delivered to the customer 104. Moreover, the voice-to-text converter 118 is capable of handling a wide range of languages and dialects. The voice-to-text converter 118 utilizes a Twilio owned by Twilio Inc having headquarters in San Francisco, California. The Twilio is used to convert the voice interaction into text. Moreover, the Twilio converts follow-up action 130 to voice for voice interaction by the voice module 106 with the customer 104.

In at least one embodiment, the voice to text converter 118, such as Twilio, is intelligent enough to identify a voicemail. When a voicemail is detected, the voice to text converter 118 calls this flow instead of going into the standard flow. So it goes, okay, this is a voicemail. I'm going straight to this flow here. And this flow passes all the variable information into a prompt and says, “you've called the customer, you've gotten through to the collections department, now basically leave a message to achieve your goal of collecting the money. And so it formulates a response and leaves the voicemail for the customer based on what information passed.” the voice to text converter 118 converts text and sounds into input data for a prompt. Below is an exemplary prompt for ChatGPT:

In operation 216, utilizing the voice script 128 by the voice module 106 for a follow-up call 130 for a real-time collection process based on the follow-up actions 126. The voice script 128 serves as the blueprint for the follow-up call 132. The voice script 128 encapsulates the necessary dialogue and instructions that need to be communicated to the customer 104, tailored to the specific context of the call response 102 and the desired outcome of the follow-up call 130. Once the voice script 128 is generated, the crawler bot 110 initiates the follow-up call 130. The voice module 106 utilizes the voice script 128 to engage with the customer 104, for executing the follow-up call 130.

The crawler bot 110 retrieves the relevant customer 104 data from the database 108, and corresponding the response 102 on the call 114 that may influence the content and tone of the follow-up call 130. The retrieval of the response 102 is essential for personalizing the follow-up call 130 and ensuring that the voice script 128 is applied in a manner that resonates with the specific customer 104 situation. For example, if the previous interaction indicated that customer 104 was facing financial difficulties, the voice script 128 might be adjusted to offer an empathetic tone and provide flexible payment options.

The crawler bot 110 provides the voice script 128 to the voice module 106. The voice module 106, once initiated by the crawler bot 110, plays the voice script 128 to the customer 104. During the follow-up call 130, the voice module 130 delivers the voice script 128 and also captures the responses of the customer 104 in real-time. The voice module 106 collects and analyzes data related to the follow-up call 130 outcome, customer responses, and overall effectiveness. The data is fed back into the AI engine 122, which uses it to refine future follow-up actions and voice scripts. Moreover, the voice module 130 manages large volumes of follow-up calls 130.

FIG. 3 is a customer handling process 300, which is an embodiment of the collection process 200 of FIG. 2. As shown, at 302 the collection process is initiated. At operation 304, the customer call begins. The customer call involves contacting the customer 104 through call 114 to remind them of the payment. At operation 306, record response, based on the call 14 the call response 102 is recorded and is stored in the database 108 and can be utilized during future interactions. At operation 308, categorize response, the received response 102 is categorized by the AI engine 122 based on the categories such as human voices, IVR system, leave a message, press buttons, just wait, call failed, and no answer. At operation 310, decide the next action, based on the received call response 102 the appropriate follow-up action 126 is determined. At operation 312, the collection process is ended.

FIG. 4 is an action generation process 400, which is an embodiment of the collection process 200 of FIG. 2. As shown, a call list 402 having the contact numbers of customer 104 is fetched. Typically, the database 108 is configured to store data corresponding to the customer 104 having the relevant information of the customer 104. The call list 402 is fetched by the crawler bot 106 and the call list 402 is provided to the voice module 106 for initiation of the call 114. The voice module is configured to receive the call response 102 and categorize the call response 102 such as human voices, IVR system, leave a message, press buttons, just wait, call failed, and no answer. The AI engine 122 is configured to determine the next follow-up action 130 based on the response type. The follow-up action 130 is taken, the follow-up action 130 include continue call 114, end call 114 or leave a message.

FIG. 5 is a call handling process 500, which is an embodiment of the collection process 200 of FIG. 2. As shown, a call list 402 having the contact numbers of the customer 104. As shown, at operation, 502, a list of customer 104 with pre-due invoices is created. Specifically, invoices that are 10 days past the vendor registration date plus 5 days from the PO (Purchase Order) date are created. The data is stored in a Tesario workspace, which needs to be created if it doesn't already exist. Typically, the calls 114 are made daily. Each customer 104 is to be contacted only once within the last 15 days, except in specific scenarios. The customers 104 with direct debit setups and GFI Resellers are excluded from the list. The different scenarios for handling the call are:
Scenario 1: The call 114 is picked up, and the customer 104 should not be called again.
Scenario 2: The call 114 is rejected.
Scenario 3: The call 114 is picked up and hung up. Only two calls are allowed for such customers.
Scenario 4: Voicemail/IVR. The team must decide what message to leave.
Scenario 5: The concerned party did not pick up the call (considered as the third phase).

At operation 504, data required per customer is identified. The data include due amount, due date, invoice number, BU name (caller), class, indicating the need for processing, invoice issuing entity (your company or subsidiary). At operation 506, the call 114 is processed. The caller (such as voice module 106) introduces themselves, mentioning the entity they represent and the product associated with the overdue invoice. The call 114 is aimed at determining whether the customer needs assistance in settling the invoice. And provides options to the customer 104.
Press 1: Vendor registration
Press 2: PO information
Press 3: Invoice copy
Press 4: Other (take speech recording)
Press 0: No blockers to payment

As operation 508, based on the scenario customer 104 picks up the call 114 and presses the respective option provided. If the customer 104 selects Press 1 (Vendor Registration): A ticket is created and forwarded to the Finance department. The customer 104 will receive an email with the ticket details and next operations. Press 2 (PO Information): Similar to Vendor Registration, a ticket is created and handled by Finance. Press 3 (Invoice Copy): A ticket is created for providing the customer 104 with a copy of the invoice. Press 4 (Other-Take Speech Recording): The voice module 106 records the speech of the customer 104. The recorded speech is processed iteratively, and a response is generated. Press 0 (No Blockers to Payment): The customer 104 confirms there are no blockers for timely payment. The call 114 ends with a confirmation message.

FIG. 6 is a pre-due invoice call managing process 600, which is an embodiment of the collection process 200 of FIG. 2. As shown, at operation 602 workspace data download from Tesorio, which contains information on the customers 104 and their invoices. At operation 604, clean the workspace data by first copying contact information from a contact master list (a separate table) and checking if existing data exists for an invoice; existing data is not added to the pre-due call data. At operation 606, identify data that satisfies the conditions for the call 114 to be made today. The conditions include invoices that are due in less than 15 days and the result of the previous call has fallen into Scenario 2 (call rejected) or Scenario 3 (call picked up and hung up) as explained in FIG. 5. At operation 608, check if the customer 104 has been crawled in the last 3 to 5 days. At operation 610, if the customer 104 has been crawled recently (within the last 3 to 5 days), the process continues directly to creating a list of final calls to be made. If not, the crawler bot is triggered to crawl the necessary data. At operation 612, once the necessary data is gathered and filtered, a final list of calls is prepared. At operation 614, the pre-due voice module 106 is responsible for making the calls 114 to the customers 104 based on the final list by utilizing JavaScript (JS), and Twilio. At operation 616, the results from the voice module 106, including the outcomes of the calls 114, are stored in the database 108. The database contains tables for: customers, pre-due invoices, overdue invoices, pre-due calls, overdue calls, and crawler calls.

FIG. 7-12 are an exemplary workflow diagram 700, 800, 900, 1000, 1100, 1200 for outbound collections process. Referring to FIG. 7, At operation 702 check whether the call 114 is being made to a demo account and has two possible outcomes: “Success” and “Fail.” At operation 704, the workflow proceeds to make a GET request to a Google Sheets URL to retrieve configuration data and also has two possible outcomes: “Success” and “Fail.” If the GET request is successful, the workflow continues to the next operation. If it fails, the process ends “Terminate”. At operation 706, following a successful configuration retrieval, the workflow makes a POST request to another Google Sheets URL, to obtain invoice information and it also has two outcomes: “Success” and “Fail.” On success, the flow continues. On failure, it terminates. At operation 708, block handles a piece of logic or decision-making based on the data retrieved. It uses JavaScript to process the data. At operation 710, check a condition, based on the data or result of the JavaScript code. If the condition is true, it leads to an “Abort Script,” and the process terminates. If false, the process continues. At operation 712, a predefined message, indicating that the customer's contact number is not monitored and the call cannot proceed. This is triggered if at operation 710 the condition evaluates to true. At operation 714, if all conditions are met, successful completion of the workflow, allowing for further processing or sending a success message. At operation 716, terminate, signifying the end of the workflow based on different conditions (failures or success).

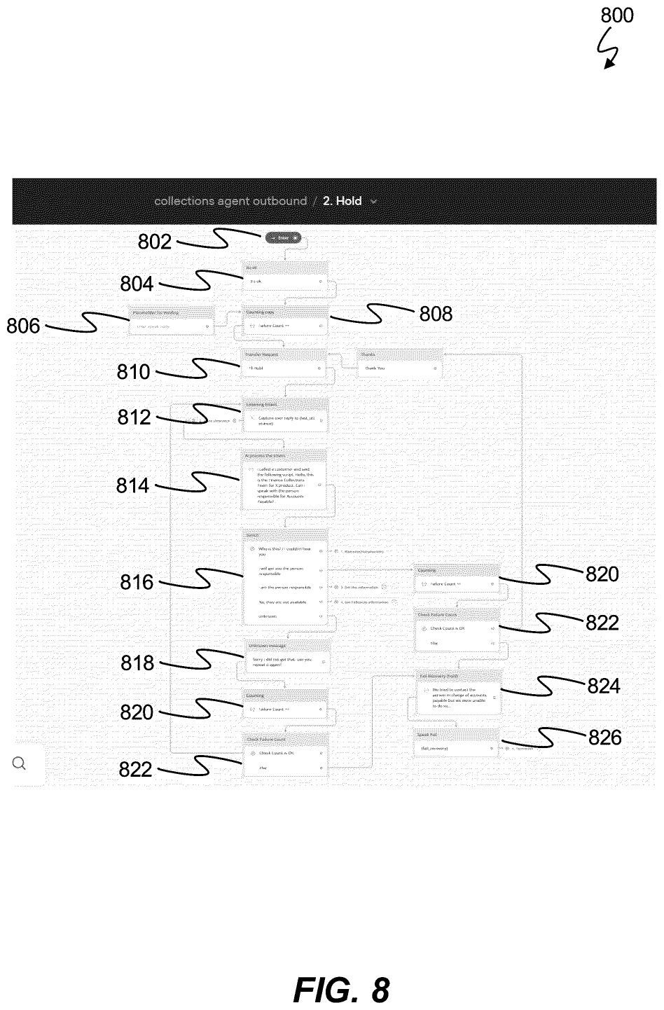

Referring to FIG. 8, At operation 802, the process starts when the agent initiates the hold process. At operation 804, it's ok for the branch to handle a scenario where the hold is acknowledged or confirmed as acceptable by the caller. At operation 806, a placeholder for holding, where a message or interaction occurs while the caller is on hold. At operation 808, a counter is involved in tracking the number of hold attempts or failures. If a failure count reaches a certain threshold, the workflow will terminate or take another action. At 810, if the caller requests a transfer. At operation 812, the intent or response of the caller is captured, or the agent listens to what the caller says and processes the intent to determine the next operations. At operation 814, the AI engine 122 processes the intent, for example: The caller say something like, “I called a customer and put them on hold. Please transfer to the Finance Contacts,” etc. Based on this, the system or agent might take specific actions, like transferring to the appropriate person or department. At operation 816, identify who is speaking, for example “Who is this?”/“I couldn't hear you”, “I will get you the person responsible,” “I am the person responsible,” “No, they are not available,” or unknown. At operation 818, in case of unknown message handling sorry, I did not get you. Can you repeat it again? At operation 820, tracks failures and checks the failure count. If the count exceeds a threshold, the process terminates. At operation 822, check failure counts are within an acceptable range. At operation 824, if the failure counts not in the acceptable range try to recover by taking alternative actions, such as following up or sending a message to inform the user about the failure. At operation 826, providing a voice response or message to the caller if the process fails then the process terminates.

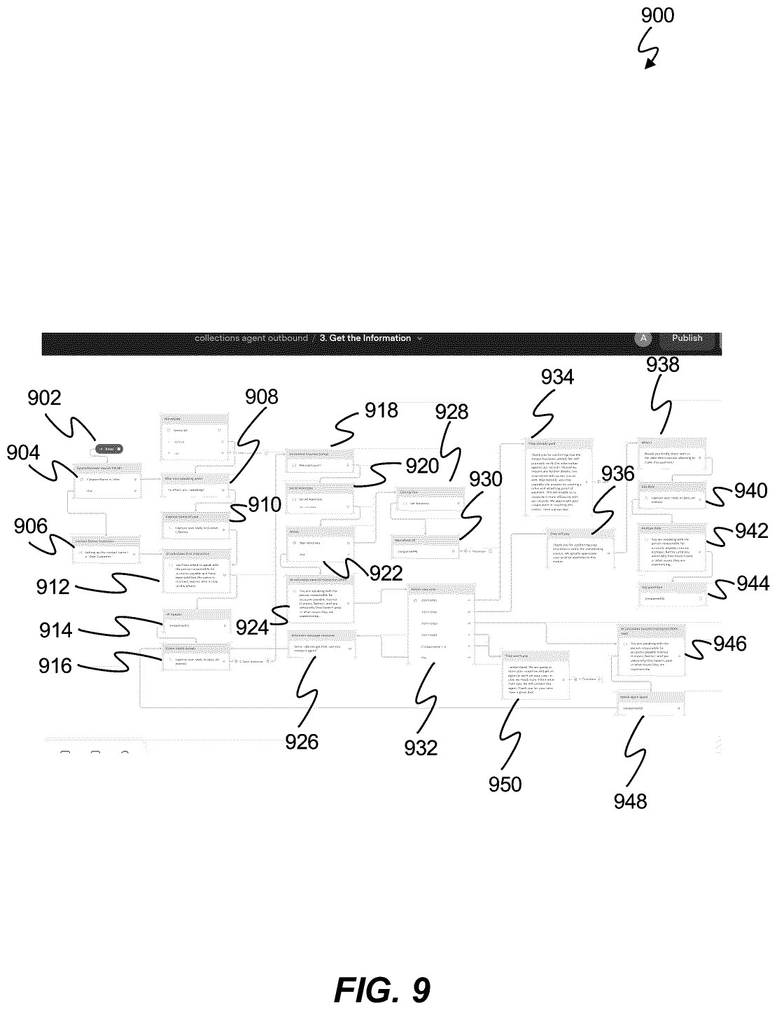

Referring to FIG. 9, At operation 902, starts the process for fetching information. At operation 904, call customer 104 and check the customer's details. At operation 906, if the customer's details are correct contact customer 114 by “dear customer”. At operation 908, if the customer's details are incorrect ask the customer 114 “To whom am I speaking”? At operation 910, capture the user's name for future reference. At operation 912, the AI engine 122 calculates the final interaction of the prompt “You have asked to speak with the person responsible for account payable and have been told that the name is {contact name} who is now on the phone”. At operation 914, the response of the speaker is captured. At operation 916, listen to the response to identify the intent until the speaker speaks. At operation 918, increment counter to manage how many attempts have been made. At operation 920, set the AI engine 122 attempts to record the outcome of the attempts. At operation 922, identify if maximum attempts are made, if no more attempts are to be made. If maximum attempts are not made, follow operation 924, and the AI engine 122 calculates the second message. “you are speaking with the person responsible for the account payable {named {contact name}} and you asked why they haven't paid or what issues they are experiencing”. At operation 926, an unknown message responds “Sorry I did not get you, can you repeat it again?” and the operation from 916 repeats. If maximum attempts are made, follow operation 928 closing out, fail recovery closing the process. At operation 930, the new block prepares for termination of the process. After operation 924, at operation 932 switch to a new case based on 6 options. At operation 934, option 1: the invoice already paid, the customer 104 is prompted by “thank you for confirming that the invoice has been settled. We will promptly verify this information against our records. Should we require any further details, rest assured we will contact you as well. Alternatively, you may expedite the process by creating a ticket and attaching proof of payment. This will enable us to reconcile it more efficiently with our records. We appreciate your cooperation in resolving this matter. Have a great day!”. At operation 936, option 2: they will pay the invoice, the customer 104 is prompted by “Thank you for your confirmation to settle the outstanding invoice. We greatly appreciate your prompt attention to this matter.” At operation 938, asking the customer 104 when they will pay the invoices based on option 2 by prompting “would you kindly share with us the date when you are planning to make this payment”. At operation 940, capture the date provided by the customer 104. At operation 942, analyzing the date provided by the customer. At operation 944, saying goodbye to the customer 104. At operation 946, option 3: AI engine 122 calculates the second interaction “you are speaking with the person responsible for account payable {named {contact name}} and you asked why they haven't paid or what issues they are experiencing”. At operation 948, customer 104 speaks again then operation 914 repeats. At operation 950, if option 4 they won't pay the invoice, the customer 104 is prompted by “I understand. We are going to store your response and get an agent to work on your case. In case we need more information from you, we will contact you again. Thank you for your time. Have a great day!”

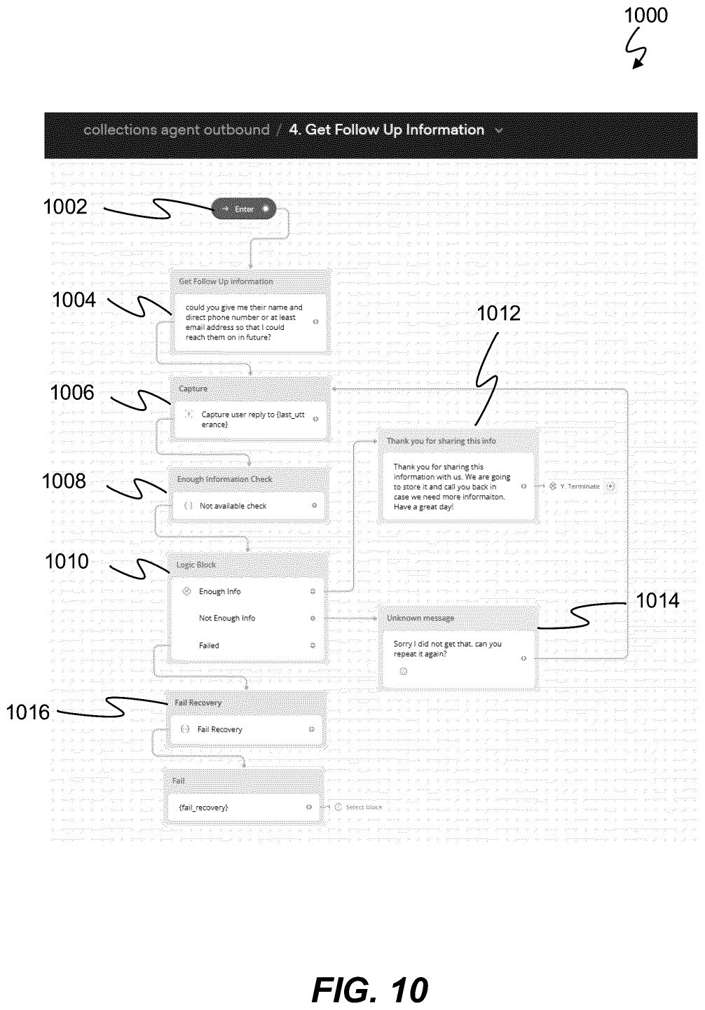

Referring to FIG. 10, at operation 1002, the process starts when the agent needs to gather follow-up information from the customer 104. At operation 1004, the agent asks the customer for additional contact information, which may be necessary for future follow-up interactions by asking “Could you give me their name and direct phone number or at least email address so that I could reach them in the future? At operation 1006, capturing user reply. At operation 1008, check if enough information provided by the customer is sufficient for follow-up purposes. At operation 1010, identifying information provided by the customer is enough info, not enough info or failed. If the provided information is sufficient, the process continues to the next operation. If the provided information is insufficient, the process will ask for clarification or more details. If the information cannot be obtained or there is an issue. At operation 1012, if the information provided is enough, share a prompt: “Thank you for sharing this information with us. We are going to store it and call you back in case we need more information. Have a great day”. At operation 1014, if the information provided is not enough, share a prompt: “Sorry, I did not get that. Can you repeat it again?”. At operation 1016, if the information provided is failed, failed recovery is initiated which involves retrying the information request. At operation 1018, if the recovery fails or the process cannot proceed, the system logs the interaction as a failure and terminates the action.

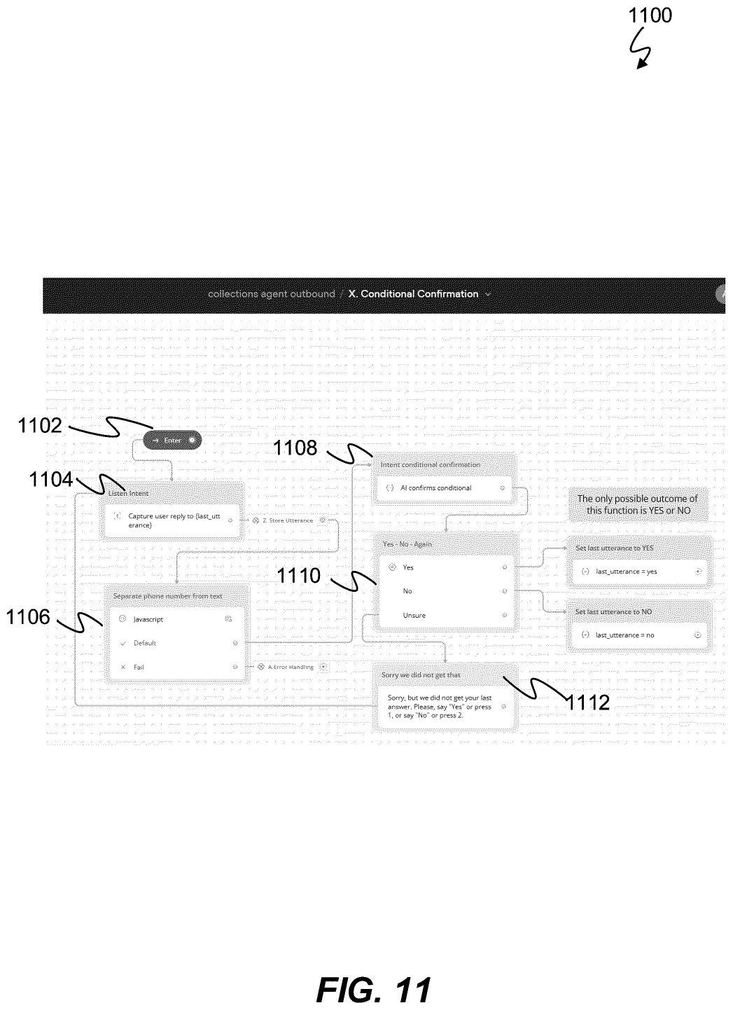

Referring to FIG. 11, At operation 1102, starting the process for the conditional confirmation process. At operation 1104, capture user reply to understand the customer 104 answer to a particular question or condition being confirmed. At operation 1106, separate phone numbers from text by using JavaScript to separate any phone number provided by the customer from the rest of their text response. If the script doesn't recognize the input correctly, the process defaults to handling it differently. If the phone number cannot be separated or recognized, the system may flag this as an error, leading to a fail or error handling process. At operation 1108, the AI engine 122 analyzes the customer's response to confirm whether it meets the condition required for a “Yes” or “No” decision. At operation 1110, Yes-No-Again, If the customer's response confirms the condition as “Yes,” the process sets the last utterance to “yes.” If the response is a “No,” the process sets the last utterance to “no.” If the response is unclear, the system may ask for confirmation again or move to an error handling operation. At operation 1112, if the response is unclear the customer 104 is prompted “Sorry, but we did not get your last answer. Please, say ‘Yes’ or press 1, or say ‘No’ or press 2.” And the process repeats from operation 1104.

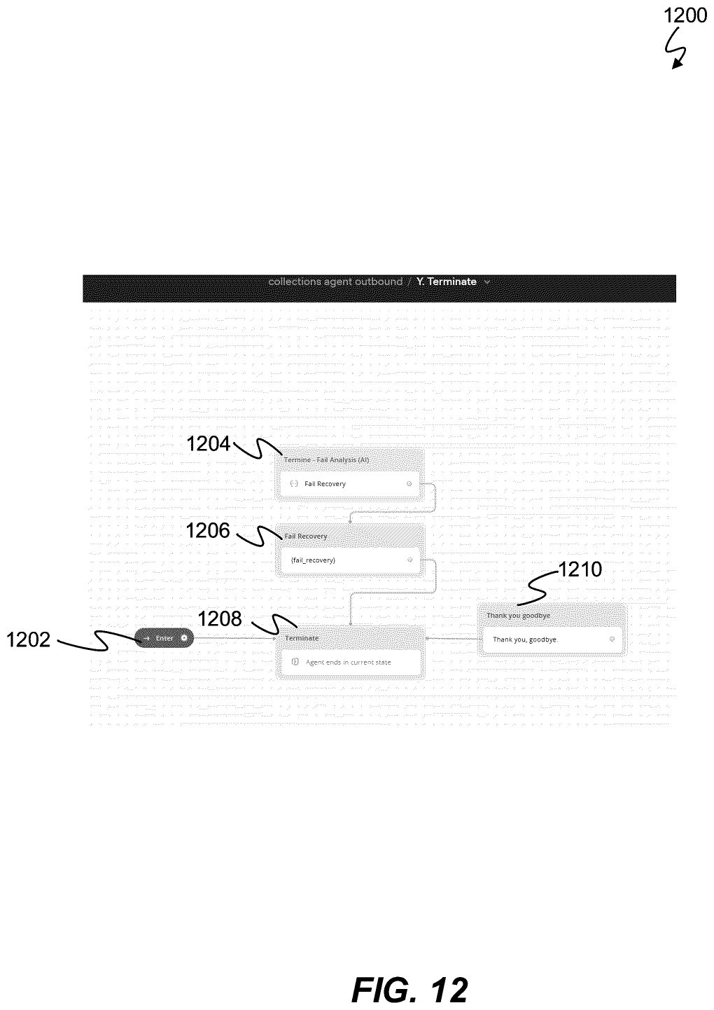

Referring to FIG. 12, At operation 1202, starting point of the termination process. At operation 1202, Termine-fail utilizes AI engine 122 to analyze failure. At operation 1206, fail recovery indicates a variable or placeholder for a recovery process if a failure occurs. At operation 1208, the current state is terminated. At operation 1210, “Thank you, goodbye” is prompted to the customer 104 on the successful termination of the call 114.

FIG. 13 is a block diagram illustrating a network environment in which a collection system 100 and collection process 200 may be practiced. Network 1302 (e.g. a private wide area network (WAN) or the Internet) includes a number of networked server computer systems 1304(1)-(N) that are accessible by client computer systems 1306(1)-(N), where N is the number of server computer systems connected to the network. Communication between client computer systems 1306(1)-(N) and server computer systems 1304(1)-(N) typically occurs over a network, such as a public switched telephone network over asynchronous digital subscriber line (ADSL) telephone lines or high-bandwidth trunks, for example communications channels providing T1 or OC3 service. Client computer systems 1306(1)-(N) typically access server computer systems 1304(1)-(N) through a service provider, such as an internet service provider (“ISP”) by executing application specific software, commonly referred to as a browser, on one of client computer systems 1306(1)-(N).

Client computer systems 1306(1)-(N) and/or server computer systems 1304(1)-(N) are specialized computer programmed to improve conventional computer systems to implement and utilize the collection system 100 and collection process 200. The type of computer system that can be specially programmed to implement and utilize the collection system 100 and collection process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the collection system 100 and collection process 200 can be implemented using code stored in a tangible, non-transient computer readable medium and executed by one or more processors. In at least one embodiment, the collection system 100 and collection process 200 can be implemented completely in hardware using, for example, logic circuits and other circuits including field programmable gate arrays.

Embodiments of the collection system 100 and collection process 200 can be implemented on a computer system such as a special-purpose, special-programmed computer 1400 illustrated in FIG. 14. Input user device(s) 1410, such as a keyboard and/or mouse, are coupled to a bi-directional system bus 1418. The input user device(s) 1410 are for introducing user input to the computer system and communicating that user input to processor 1413. The computer system of FIG. 14 generally also includes a non-transitory video memory 1414, non-transitory main memory 1415, and non-transitory mass storage 1409, all coupled to bi-directional system bus 1418 along with input user device(s) 1410 and processor 1413. The mass storage 1409 may include both fixed and removable media, such as a hard drive, one or more CDs or DVDs, solid state memory including flash memory, and other available mass storage technology. Bus 1418 may contain, for example, 32 of 64 address lines for addressing video memory 1414 or main memory 1415. The system bus 1418 also includes, for example, an n-bit data bus for transferring DATA between and among the components, such as CPU 1409, main memory 1415, video memory 1414 and mass storage 1409, where “n” is, for example, 32 or 64. Alternatively, multiplex data/address lines may be used instead of separate data and address lines.

I/O device(s) 1419 may provide connections to peripheral devices, such as a printer, and may also provide a direct connection to a remote server computer systems via a telephone link or to the Internet via an ISP. I/O device(s) 1419 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 1409, into main memory 1415 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1413, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1415 is comprised of dynamic random access memory (DRAM). Video memory 1414 is a dual-ported video random access memory. One port of the video memory 1414 is coupled to video amplifier 1416. The video amplifier 1416 is used to drive the display 1417. Video amplifier 1416 is well known in the art and may be implemented by any suitable means. This circuitry converts pixel DATA stored in video memory 1414 to a raster signal suitable for use by display 1417. Display 1417 is a type of monitor suitable for displaying graphic images.

The computer system described above is for purposes of example only. The collection system 100 and collection process 200 may be implemented in any type of computer system or programming or processing environment. It is contemplated that the collection system 100 and collection process 200 might be run on a stand-alone computer system, such as the one described above. The collection system 100 and collection process 200 might also be run from a server computer systems system that can be accessed by a plurality of client computer systems interconnected over an intranet network. Finally, the collection system 100 and collection process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method for guiding an Artificial Intelligence (AI) engine to process call responses in a collection process comprising:
executing codes using one or more processors of a computer system to cause the computer system to perform operations comprising:
utilizing a database via a crawler bot to fetch customer details, wherein the database includes contact numbers of customers;
using a voice module of an accounting system to initiate a call on the contact numbers of customers received from the database and records the call response;
receiving the call response from the call made by the voice module, wherein the call response is response from contacted numbers, including human voice, Interactive Voice Response (IVR) system, recorded message, or silence;
processing the received call response using a voice-to-text converter to convert the call response into a text response;
utilizing the AI engine to classify the call response based on the text response into categories in the database to recognize specific speech patterns and keywords to identify the nature of the call response, wherein categories include human voices, IVR system, leave a message, press buttons, just wait, call failed, no answer;
generating a prompt via a prompt generator to guide the AI engine in utilizing the categorized call response to generate appropriate follow-up actions;
using the voice-to-text converter to convert the follow-up action into a voice script; and
using the voice script by the voice module for a follow-up call for a real-time collection process based on the follow-up actions.

2. The method of claim 1 wherein identifying based on the initial response whether the call is answered by human voice, Interactive Voice Response (IVR) system, recorded message, or silence to utilize the AI engine to generate corresponding follow-up actions for each call response.

3. The method of claim 1 wherein utilizing a NetSuite API by the accounting system for managing the database.

4. The method of claim 1 further comprising:
utilizing via the AI engine a plurality of algorithms for the call response categorization, voice recognition, and natural language processing to classify call responses and generate appropriate follow-up actions.

5. The method of claim 1 wherein training of the AI engine involves the iterative adjustment of parameters to improve the accuracy of classifying call responses and reduce false positives or negatives.

6. The method of claim 1 wherein the voice-to-text converter is configured to utilize a voice recognition model to allow the AI engine to classify and differentiate between human voices and recorded messages for categorizing the call responses.

7. The method of claim 1 wherein when the voice module detects the IVR system, the voice module can automatically navigate the IVR menu using predetermined inputs to reach the appropriate department for the collection process.

8. A system for guiding an Artificial Intelligence (AI) engine to process call responses in a collection process comprising:
one or more processors of a computer system;
a memory, coupled to the one or more processors, that stores code and execution of the code by the one or more processors causes the computer system to perform operations comprising:
executing codes using one or more processors of a computer system to cause the computer system to perform operations comprising:
utilizing a database via a crawler bot to fetch customer details, wherein the database includes contact numbers of customers;
using a voice module of an accounting system to initiate a call on the contact numbers of customers received from the database and records the call response;
receiving the call response from the call made by the voice module, wherein the call response are responses from contacted numbers, including human voice, Interactive Voice Response (IVR) system, recorded message, or silence;
processing the received call response using a voice-to-text converter to convert the call response into a text response;
utilizing the AI engine to classify the call response based on the text response into categories in the database to recognize specific speech patterns and keywords to identify the nature of the call response, wherein categories include human voices, IVR system, leave a message, press buttons, just wait, call failed, no answer;
generating a prompt via a prompt generator to guide the AI engine in utilizing the categorized call response to generate appropriate follow-up actions;
using the voice-to-text converter to convert the follow-up action into a voice script; and
using the voice script by the voice module for a follow-up call for a real-time collection process based on the follow-up actions.

9. The system of claim 1 wherein identifying based on the initial response whether the call is answered by human voice, Interactive Voice Response (IVR) system, recorded message, or silence to utilize the AI engine to generate corresponding follow-up actions for each call response.

10. The system of claim 1 wherein utilizing a NetSuite API by the accounting system for managing the database.

11. The system of claim 1 further comprising:
utilizing via the AI engine a plurality of algorithms for the call response categorization, voice recognition, and natural language processing to classify call responses and generate appropriate follow-up actions.

12. The system of claim 1 wherein training of the AI engine involves the iterative adjustment of parameters to improve the accuracy of classifying call responses and reduce false positives or negatives.

13. The system of claim 1 wherein the voice-to-text converter is configured to utilize a voice recognition model to allow the AI engine to classify and differentiate between human voices and recorded messages for categorizing the call responses.

14. The system of claim 1 wherein when the voice module detects the IVR system, the voice module can automatically navigate the IVR menu using predetermined inputs to reach the appropriate department for the collection process.
